(19) United States
(12) Patent Application Publication
(10) Pub. No.: US 2011/0143778 A1
(43) Pub. Date: Jun. 16, 2011

(54) SYSTEM AND METHOD FOR ESTIMATING POSITION OF LOST MOBILE TERMINAL, AND MOBILE TERMINAL

(75) Inventors: Yoo La HWANG, Daejeon (KR); Jeom Hun LEE, Daejeon (KR); Byoung Sun LEE, Daejeon (KR); Sang Uk LEE, Daejeon (KR)

(73) Assignee: ELECTRONICS AND TELECOMMUNICATIONS RESEARCH INSTITUTE, Daejeon-City (KR)

(21) Appl. No.: 12/649,324

(22) Filed: Dec. 29, 2009

(30) Foreign Application Priority Data
Dec. 15, 2009 (KR) 10-2009-0124983

(51) Int. Cl. H04W 24/00

(52) U.S. Cl. 455/456.3

(57) ABSTRACT

Provided are a system and method for estimating position of lost mobile terminal and a mobile terminal. The system for estimating position of lost mobile terminal includes a plurality of base stations and a computing apparatus. Each of the base stations transmits an activation signal, receives a terminal ID from the mobile terminal in response to the activation signal, and transmits a reception time of the terminal ID and the terminal ID. The computing apparatus estimates a position of the mobile terminal corresponding to the terminal ID on the basis of the reception time and a position of each of the base stations.

### CROSS-REFERENCE TO RELATED APPLICATIONS

This application claims priority under 35 U.S.C. §119 to Korean Patent Application No. 10-2009-0124983, filed on Dec. 15, 2009, in the Korean Intellectual Property Office, the disclosure of which is incorporated herein by reference in its entirety.

### TECHNICAL FIELD

The following disclosure relates to a position estimation system and method, which can estimate and find the position of a lost mobile terminal even when a mobile terminal is lost and a power supply source is depleted.

### BACKGROUND

Recently, the position of a lost mobile phone that is being serviced by a communication service provider may be tracked until before a power supply source is turned off, but it is impossible to accurately estimate a position and a street name may roughly be tracked as the position of the lost mobile phone. The error of tens to hundreds or more meters occurs between a real loss position and an estimated position. Moreover, there are limitations in that the power supply source of the lost mobile phone is not continuously kept. Furthermore, when the loss of a mobile phone is not simple loss or the mobile phone has been stolen, it is impossible to find the mobile phone. A position that is tracked through current service is only a rough position which is close to a base station, and when a lost mobile phone is disposed inside a house or a building, only the position of a near base station is provided because it is difficult to estimate an accurate position with Global Positioning System (GPS) data.

There are many error factors when estimating a position. Because of herability in which the signal of another base station is weakened when the mobile phone is in the center of a base station, a time sync error, analysis of correlator resolution, delay by repeaters, Non-Line of Sight (NLOS) and a multipath error among the error factors, there are limitations in the measuring of the distance between a base station and a mobile phone.

A distance estimation method, based on Time-Of-Arrival (TOA)/Time-Difference-Of-Arrival (TDOA), Angle-Of-Arrival (AOA) or a micro cell, still has many error factors.

### SUMMARY

In one general aspect, a system for estimating position of lost mobile terminal includes: a plurality of base stations transmitting an activation signal, receiving a terminal identification (ID) from the mobile terminal in response to the activation signal, and transmitting a reception time of the terminal ID and the terminal ID; and a computing apparatus estimating a position of the mobile terminal corresponding to the terminal ID on the basis of the reception time and a position of each of the base stations.

In another general aspect, a mobile terminal for estimating position of lost mobile terminal includes: a main terminal; and a sub-terminal supplying a sub power supply source to the main terminal in response to an activation signal, and transmitting an activation command to the main terminal, wherein the main terminal transmits a terminal ID to a base station, in response to the sub power supply source and the activation command.

In another general aspect, a method for estimating position of lost mobile terminal includes: transmitting an activation signal; receiving a terminal ID from the mobile terminal in response to the activation signal; and estimating a position of the mobile terminal on the basis of a position of each base station and a reception time of the terminal ID.

Other features and aspects will be apparent from the following detailed description, the drawings, and the claims.

### BRIEF DESCRIPTION OF THE DRAWINGS

FIG. 1 is a block diagram illustrating a mobile terminal according to an exemplary embodiment.

FIG. 2 is a block diagram illustrating a system for estimating position of lost mobile terminal according to an exemplary embodiment.

FIG. 3 is a block diagram illustrating a system for estimating position of lost mobile terminal according to another exemplary embodiment.

FIG. 4 is a block diagram for describing a method of estimating position in the system of FIG. 3.

FIG. 5 is a flow chart illustrating a method for estimating position of lost terminal according to another exemplary embodiment.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments will be described in detail with reference to the accompanying drawings.

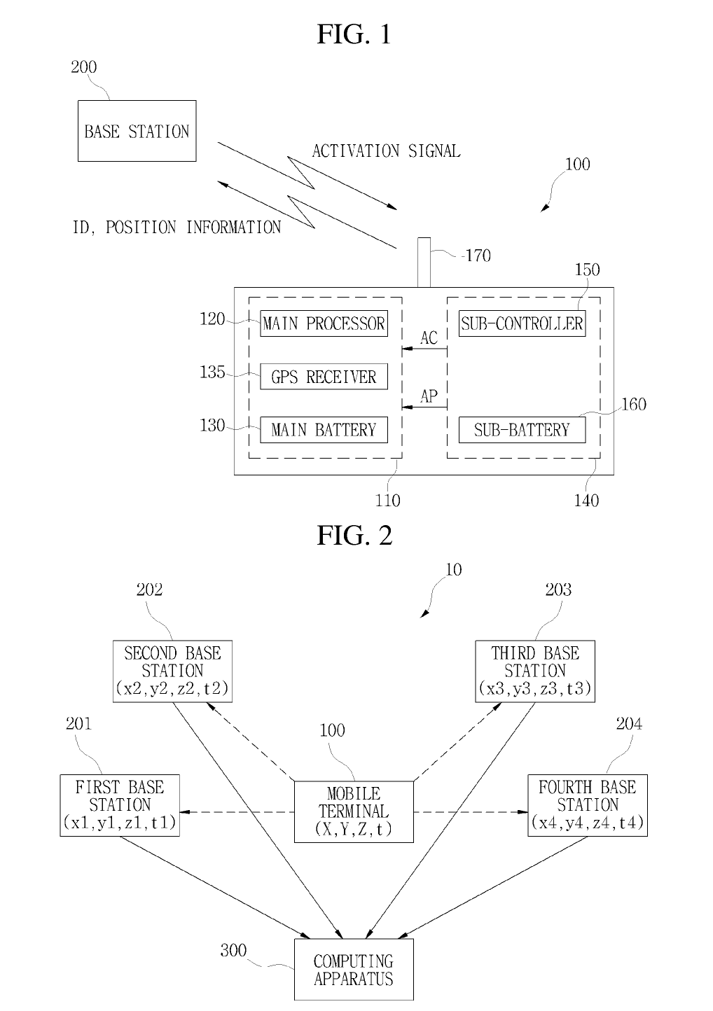

A mobile terminal according to an exemplary embodiment will be described below with reference to FIG. 1. FIG. 1 is a block diagram illustrating a mobile terminal according to an exemplary embodiment.

Referring to FIG. 1, a mobile terminal 100 according to an exemplary embodiment includes a main terminal 110 and a sub-terminal 140.

The main terminal 110 is a related art mobile terminal. That is, the main terminal 110 includes an antenna 170 for transmitting/receiving audio data, character data or video data, a main processor 120 for processing transmitted/received data, a main battery 130 for supplying a power supply source for driving, and a GPS receiver 135.

The sub-terminal 140 is a sub-module that is driven when the mobile terminal 100 is lost and the main battery 130 is depleted, and includes a sub-battery 160 and a sub-controller 150.

The sub-terminal 140 maintains a turn-off state or a sleep mode when a charge remains in the power supply source of the main battery 130, and then, when the power supply source of the main battery 130 is depleted, the sub-terminal 140 operates at a power equal to the degree in which an activation signal may be received from the outside. The sub-terminal 140 shares the antenna 170 with the main terminal 110. When the main battery 130 is depleted, the sub-terminal 140 is driven and receives an activation signal based on a specific protocol from the base station 200. In response to the activation signal, the sub-terminal 140 supplies a power supply source ‘AP’ to the main terminal 110 through the sub-battery 160 and transfers an activation command ‘AC’ to the main terminal 110. For receiving and responding the activation signal, the sub-controller 150 may include a low noise amplifier, a demodulator, and a signal processor.

The main terminal 110, which receives the power supply source ‘AP’ from the sub-battery 160 and receives the activation command ‘AC’, transmits a signal including its own terminal identification (ID) to the base station 200. The signal that is transmitted from the main terminal 110 to the base station 200 may further include the position information of the mobile terminal 100. The power supply source supplied from the sub-battery 160 may have a power equal to the degree in which the mobile terminal 100 may transmit the terminal ID and its own position information to the base station 200. Herein, the position information includes at least one of the distance between the mobile terminal 100 and the base station 200, the distance between a GPS satellite and the mobile terminal 100 and the distance between the GPS satellite and the base station 200, and may be final position information that is received from the GPS satellite to the GPS receiver 135 before the main battery 130 is depleted. Alternatively, the GPS receiver 135, which receives the power supply source ‘AP’ from the sub-battery 160 and is activated, may receive a position information signal from the GPS satellite and transmit the received signal to the base station 200.

The mobile terminal 100 receives the activation signal from the base station 200 to operate with the sub-battery 160 even when the main battery 130 is depleted. In response to the activation signal, the mobile terminal 100 transmits the terminal ID or its own position information to the base station 200, thereby enabling to estimate the position of the lost mobile terminal 100. A method in which the base station 200 estimates the position of the lost mobile terminal 100 will be described below with reference to FIGS. 2 through 4.

A terminal ID is an identifier that is given to each terminal, and an activation signal transmitted from the base station 200 may correspond to the terminal ID in one-to-one relationship. For example, the base station 200 may generate and transmit an activation signal corresponding to the ID of a mobile terminal in which the report of loss has been made. The lost mobile terminal 100 transmits a terminal ID and position information in response to an activation signal pertaining to it. That is, the mobile terminal 100 may transmit a terminal ID and position information in response only to an activation signal corresponding to its own ID. For example, the sub-terminal 140 provides a sub power supply source ‘AP’ and an activation command ‘AC’ to the main terminal 110 in response only to an activation signal corresponding to its own ID.

Hereinafter, the following description will be made on a system and method for estimating a position when the mobile terminal 100 is lost.

A system and method for estimating position of lost mobile terminal according to an exemplary embodiment will be described below with reference to FIG. 2. FIG. 2 is a block diagram for describing a system and method for estimating position of lost mobile terminal according to an exemplary embodiment.

A system 10 for estimating position of lost mobile terminal according to an exemplary embodiment includes a plurality of base stations 201 to 204, and a computing apparatus 300.

The base stations 201 to 204 (for example, four base stations) adjacent to the lost mobile terminal 100 transmit respective activation signals to the mobile terminal 100 and transmit a signal including a terminal ID, which is transmitted by the mobile terminal 100 in response to the activation signal, to the computing apparatus 300.

The respective base stations 201 to 204 transmit reception times “t1 to t4” when the terminal ID is received from the mobile terminal 100, to the computing apparatus 300.

The computing apparatus 300 estimates the position of the mobile terminal 100 by using the positions of the respective base stations 201 to 204, reception times “t1 to t4” when the respective base stations 201 to 204 receive a signal transmitted from the mobile terminal 100 and a terminal ID.

Specifically, when the mobile terminal 100 is not disposed in a herability position and the error of observation data such as time delay or multipath error is excluded, the distance from the position (X, Y, Z, t) of the mobile terminal 100 to the position (x₁, y₁, z₁, t₁) of a first base station 201, the distance from the position (X, Y, Z, t) of the mobile terminal 100 to the position (x₂, y₂, z₂, t₂) of a second base station 202, the distance from the position (X, Y, Z, t) of the mobile terminal 100 to the position (x₃, y₃, z₃, t₃) of a third base station 203, and the distance from the position (X, Y, Z, t) of the mobile terminal 100 to the position (x₄, y₄, z₄, t₄) of a fourth base station 204 are expressed as Equation (1), respectively.

Rⱼ=sqrt((X−xⱼ)̂2+(Y−yⱼ)̂2+(Z−zⱼ)̂2) (1)

where j=1, 2, 3, 4

For the respective base stations 201 to 204, the following 1×4 matrix may have at least four or more observation data and thereby configure 4×4 or 4 or more x4 matrix. A state ‘X’ to be estimated is X=[ΔX, ΔY, ΔZ, Δt].

Aⱼ=[−(X−xⱼ)/Rⱼ, −(Y−yⱼ)/Rⱼ, −(Z−zⱼ)/Rⱼ, −c] (2)

where c is the velocity of light, t is time when the mobile terminal 100 transmits a terminal ID and position information to the respective base stations 201 to 204, and t₁ to t₄ are times when the respective base stations 201 to 204 receive the terminal ID and the position information.

The position (X, Y, Z, t) of the mobile terminal 100 is estimated from observation data “R₁ to R₄” for distances from the respective base stations 201 to 204 to the mobile terminal 100, through a least square scheme or a Kalman filter. Herein, the observation data “R₁ to R₄” for the distances may be data that are obtained by multiplying the velocity of light by difference between times “tᵢ to t₄” when the respective base stations 201 to 204 receive a terminal ID and time ‘t’ when the mobile terminal 100 transmits the terminal ID. In this case, when transmitting the terminal ID, the mobile terminal 100 may transmit the time ‘t’ to the base stations 201 to 204 together with the terminal ID.

The position (X, Y, Z, t) of the mobile terminal 100 may be estimated using Equation (3).

X=(Aⱼ^{T}WAⱼ)⁻¹Aⱼ^{T}Lⱼ (3)

where W is a weight matrix for giving weights with the strength of a signal which is transmitted from the mobile terminal 100. Lⱼ is Rⱼ−Rⱼ0−c*dtⱼ, wherein dtⱼ is tⱼ−t, and Rⱼ⁰ is the position information of the mobile terminal 100 that is obtained with the initial value and is roughly known. When the position of the mobile terminal 100 is roughly known, the position of the mobile terminal 100 may be estimated by adding estimated X=[ΔX, ΔY, ΔZ, Δt] and an arbitrary value (X₀, Y₀, Z₀), and the position may be X=X₀+ΔX, Y=Y₀+ΔY and Z=Z₀+ΔZ.

On the other hand, when the position of the mobile terminal 100 is not known, absolute values “X, Y, Z, t” may be calculated by a least square scheme. When there are four unknowns and the number of observation data is four or more, (X, Y, Z, t) to obtain may be calculated.

Herein, the computing apparatus 300 may know the accurate positions of the respective base stations 201 to 204, and the times of the respective base stations 201 to 204 may be synchronized with the time of the computing apparatus 300. Synchronization between the time of the mobile terminal 100 and the times of the respective base stations 201 to 204 is not required. Moreover, synchronization between the time of the mobile terminal 100 and the time of the computing apparatus 300 is not required. In an exemplary embodiment, however, synchronization between the time of the mobile terminal 100 and the times of the respective base stations 201 to 204 and synchronization between the time of the mobile terminal 100 and the time of the computing apparatus 300 are not excluded. Synchronization between the time of the computing apparatus 300 and the times “tᵢ to t₄” of the respective base stations 201 to 204 may allow an accurate value to be used when estimating the position of a mobile phone, thereby enabling the accurate estimation of a position. When reception time is accurate, transmission time may accurately be estimated. This method is similar to the existing TOA, but does not require the time synchronization of the mobile phone.

The above-described position estimation method may be applied when the distances between base stations are short and NLOS or other errors are solved or are insignificant. However, when there is a limitation such as a multipath error, NLOS, herability or delay by signal repeaters, data that which are obtained from a GPS satellite may be used instead of observation data.

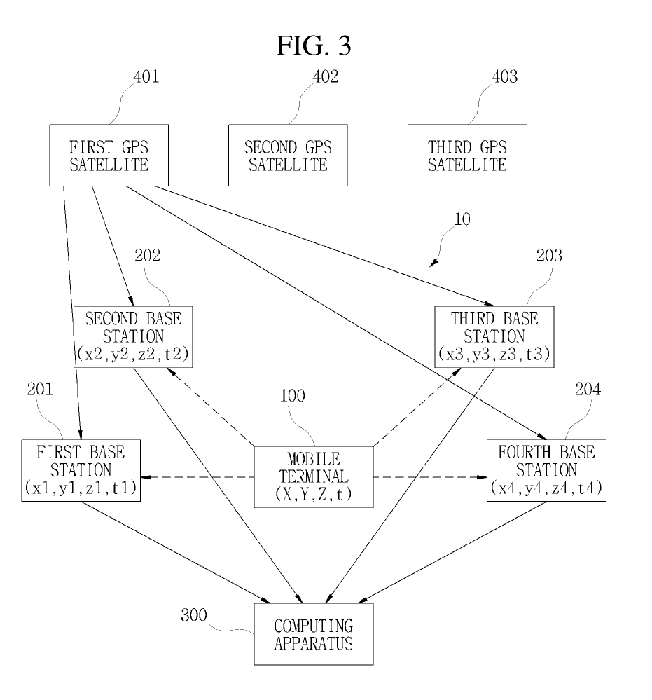

Hereinafter, a system and method for estimating position of lost mobile terminal according to another exemplary embodiment will be described with reference to FIGS. 3 and 4. FIG. 3 is a block diagram illustrating a system for estimating position of lost mobile terminal according to another exemplary embodiment. FIG. 4 is a block diagram for describing a method of estimating position in the system of FIG. 3.

Referring to FIG. 3, respective base stations 201 to 204 receive the distance between a mobile terminal 100 and a GPS satellite and the distance between a base station and the GPS satellite, from the GPS satellite. The base station transmits an elevation angle in each of the base stations 201 to 204 for the GPS satellite, the distance between the mobile terminal 100 and the GPS satellite and the distance between the base station and the GPS satellite to a computing apparatus 300.

The computing apparatus 300 estimates the position of the mobile terminal 100 on the basis of information transmitted.

Specifically, as illustrated in FIG. 4, the computing apparatus 300 may calculate the distance between a first base station and the mobile terminal 100 through the formula of a trigonometric function by using an elevation angle in the first base station for the GPS satellite, the distance between the mobile terminal 100 and the GPS satellite and the distance between the first base station and the GPS satellite. Herein, the first base station may not be a base station closest to the mobile terminal 100 among a plurality of base stations, and as a base station become farther away from the first base station, the accuracy of an elevation angle may increase.

r₁=\sqrt{R₁²+ρ₁²−2R₁ρ₁ sin α₁}

r₂=\sqrt{R₁²+ρ₂²−2R₁ρ₂ sin α₂}

R₁²−2R₁ρ₁ sin α₁+ρ₁²−r₁²=0

R₁=ρ₁ sin α₁±\sqrt{ρ₁²−r₁²}

R₁=ρ₂ sin α₂±\sqrt{ρ₂²−r₂²} (4)

With the formula of a trigonometric function such as Equation (4), the computing apparatus 300 may calculate the distances between the respective base stations 210 to 204 and the mobile terminal 100.

For increasing accuracy, the computing apparatus 300 may calculate the average value of a plurality of R₁ that have been calculated above. In this way, the computing apparatus 300 collects GPS data that includes the distance between the mobile terminal 100 and a GPS satellite and the distance between a base station and the GPS satellite to calculate the distances between base stations and a mobile phone, and if the calculated distances are substituted for Equations (1) to (3), the position of the mobile terminal 100 can accurately be calculated. Herein, for more increasing accuracy, the computing apparatus 300 can eliminate error values that are included in the distance between the mobile terminal 100 and the GPS satellite and the distance between the base station and the GPS satellite through a difference method.

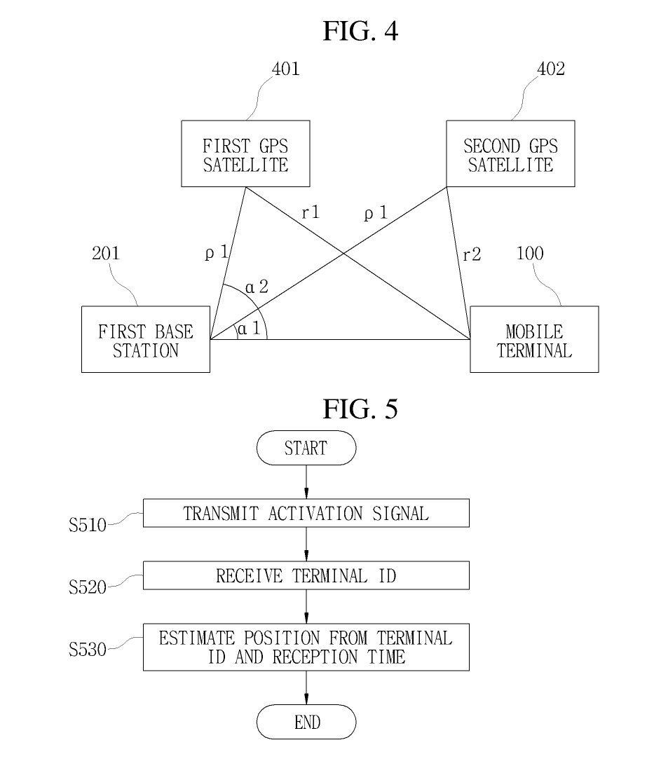

A method for estimating position of lost terminal according to another exemplary embodiment will be described below with further reference to FIG. 5. FIG. 5 is a flow chart illustrating a method for estimating position of lost terminal according to another exemplary embodiment.

First, each of the plurality of base stations 201 to 204 transmits an activation signal to the mobile terminal 100 in operation S510.

Each of the base stations 201 to 204 receives a terminal ID from the mobile terminal 100 in operation S520, and transmits the received terminal ID and the reception time of the terminal ID to the computing apparatus 300. The computing apparatus 300 estimates the position of the mobile terminal 100 on the basis of the terminal ID from the base stations 201 to 204 and the reception time when the terminal ID is received in operation S530.

In operation S530, a specific method in which the computing apparatus 300 estimates a position is as described above in the above-described embodiments.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for estimating position of lost mobile terminal, the system comprising:
a plurality of base stations transmitting an activation signal, receiving a terminal ID from the mobile terminal in response to the activation signal, and transmitting the terminal ID and a reception time of the terminal ID; and
a computing apparatus estimating a position of the mobile terminal corresponding to the terminal ID on the basis of the reception time and a position of each of the base stations.

2. The system of claim 1, wherein the computing apparatus estimates the position of the terminal through a Kalman filter or a least square scheme based on the position of each of the base stations and the reception time.

3. The system of claim 1, wherein:
a time of the each base station is synchronized with a time of the computing apparatus, and
a time of the mobile terminal is not synchronized with the time of the each base station, or the time of the mobile terminal is not synchronized with the time of the computing apparatus.

4. The system of claim 1, wherein:
the computing apparatus receives an elevation angle in the each base station for the GPS satellite from the each base station, first distance information between the each base station and the GPS satellite and second distance information between the mobile terminal and the GPS satellite,
the computing apparatus calculates a distance between the each base station and the mobile terminal on the basis of the elevation angle, the first distance information and the second distance information, and
the computing apparatus estimates the position of the mobile terminal through a Kalman filter or a least square scheme based on the calculated distance between the each base station and the mobile terminal.

5. The system of claim 1, wherein the base station generates and transmits the activation signal corresponding to the terminal ID of the mobile terminal in which a report of loss is made.

6. A mobile terminal for estimating position of lost mobile terminal, the mobile terminal comprising:
a main terminal; and
a sub-terminal supplying a sub power supply source to the main terminal in response to an activation signal, and transmitting an activation command to the main terminal,
wherein the main terminal transmits a terminal ID to a base station, in response to the sub power supply source and the activation command.

7. The mobile terminal of claim 6, wherein the sub-terminal supplies the sub power supply source when a main power supply source of the main terminal is depleted.

8. The mobile terminal of claim 7, wherein:
the main terminal comprises:
a main battery supplying the main power supply source; and
an antenna transmitting the terminal ID, and
the sub-terminal comprises:
a sub-battery supplying the sub power supply source; and
a sub-controller transmitting the activation command to the main terminal in response to the activation signal which is received from the antenna.

9. The mobile terminal of claim 6, wherein the main terminal comprises a GPS receiver receiving GPS position information, and transmits the GPS position information to the base station, wherein the GPS position information comprises distance between the mobile terminal and a GPS satellite.

10. The mobile terminal of claim 6, wherein:
the activation signal is generated and transmitted by a base station corresponding to the terminal ID, and
the sub-terminal provides the activation command and the sub power supply source in response to the activation signal corresponding to the terminal ID.

11. A method for estimating position of lost mobile terminal, the method comprising:
transmitting an activation signal;
receiving a terminal ID from the mobile terminal in response to the activation signal; and
estimating a position of the mobile terminal on the basis of a position of each base station and a reception time of the terminal ID.

12. The method of claim 11, wherein the transmitting of an activation signal comprises generating and transmitting the activation signal corresponding to the terminal ID of the mobile terminal in which a report of loss is made.

13. The method of claim 11, wherein the estimating of a position comprises estimating the position of the mobile terminal through a Kalman filter or a least square scheme based on the position of the each base station and the reception time.

14. The method of claim 11, wherein the estimating of a position comprises:
receiving first distance information between the each base station and the GPS satellite and second distance information between the mobile terminal and the GPS satellite;
calculating a distance between the each base station and the mobile terminal on the basis of the first distance information, the second distance information and an elevation angle in the each base station for the GPS satellite from the each base station; and
estimating the position of the mobile terminal through a Kalman filter or a least square scheme based on the calculated distance between the each base station and the mobile terminal.

15. The method of claim 11, wherein:
a time of the each base station is synchronized with a time of a computing apparatus, and
a time of the mobile terminal is not synchronized with the time of the each base station, or the time of the mobile terminal is not synchronized with the time of the computing apparatus.
